(19) United States
(12) Patent Application Publication
(10) Pub. No.: US 2008/0318131 A1
(43) Pub. Date: Dec. 25, 2008

(54) CATHODE ACTIVE MATERIAL FOR NONAQEOUS ELECTROLYTE BATTERY, METHOD OF PRODUCING THE SAME AND NONAQUEOUS ELECTROLYTE SECONDARY BATTERY

(75) Inventors: Haruo Watanabe, Kanagawa (JP); Tomoyo Ooyama, Fukushima (JP); Yosuke Hosoya, Fukushima (JP); Hideto Azuma, Fukushima (JP); Shigeru Fujita, Fukushima (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/134,737

(22) Filed: Jun. 6, 2008

(30) Foreign Application Priority Data
Jun. 25, 2007 (JP) 2007-166594

(51) Int. Cl. H01M 4/40; H01M 4/52; H01M 4/26

(52) U.S. Cl. 429/231.95; 429/218.1; 252/521.2; 252/518.1

(57) ABSTRACT

A cathode active material for nonaqueous electrolyte secondary battery is provided. The cathode active material includes: composite oxide particles containing at least lithium and cobalt; a coating layer disposed on at least a part of the surface of said composite oxide particles and including an oxide containing lithium and at least one coating element selected from nickel and manganese; and a surface layer disposed on at least a part of said coating layer and including an oxide containing at least one element selected from among lanthanoids.

### CROSS REFERENCES TO RELATED APPLICATIONS

The present application claims priority to Japanese Patent Application JP 2007-166594 filed in the Japanese Patent Office on Jun. 25, 2007, the entire contents of which is being incorporated herein by reference.

### BACKGROUND

The present disclosure relates to a cathode active material for nonaqueous electrolyte secondary battery, a method of producing the cathode active material and a nonaqueous electrolyte secondary battery, and for example, to a cathode active material for nonaqueous electrolyte secondary battery which includes a composite oxide containing lithium Li and cobalt Co, a method of producing the cathode active material and a nonaqueous electrolyte secondary battery using this cathode active material for nonaqueous electrolyte secondary battery.

In recent years, there has been an increased demand for small-sized and high-capacity secondary batteries along with the spread of portable devices such as video cameras and laptop-type personal computers. Secondary batteries currently used include nickel-cadmium batteries using an alkali electrolytic solution. The voltage of the nickel cadmium battery is, however, as slow as about 1.2 V and it is therefore difficult to improve energy density. For this reason, studies have been made as to lithium metal secondary batteries using a lithium metal that has a specific gravity of 0.534, that is the lowest in solid elements, is also very poor in charge potential and has the largest current capacity per weight in metal anode materials.

However, in secondary batteries using a lithium metal as the anode, a dendrite, which is dendritic lithium, precipitates on the surface of the anode when they are charged and grows during charge-discharge cycles. The growth of the dendrite gives rise to, for example, the problem that the secondary battery is deteriorated in cycle characteristics and also the problem that the dendrite breaks through a partitioned wall (separator) disposed so as to prevent the cathode from being in contact with the anode, causing the development of internal short circuits.

In light of this, as described in, for example, Japanese Patent Application Laid-Open (JP-A) No. 62-90863, a secondary battery is proposed which uses a carbonaceous material such as cokes as the anode and repeats charge-discharge by doping or dedoping alkali metal ions. It has been found that the problem concerning the deterioration of the anode in the repetition of charge-discharge operations can be avoided.

As to the cathode active material, on the other hand, inorganic compounds transition metal oxides or transition metal chalcogen containing an alkali metal are known as those capable of obtaining a voltage of about 4 V. Among these inorganic compounds, lithium composite oxides such as lithium cobaltate and lithium nickelate are most promising materials from the viewpoint of high potential, stability and long life.

Particularly, cathode active materials primarily containing lithium cobaltate are those having a high potential and it is therefore expected that these cathode active materials increase energy density by raising charge potential. However, the increase in charge voltage poses the problem concerning a deterioration in cycle characteristics. For this reason, in the methods currently used, LiMn_{1/3}Co_{1/3}Ni_{1/3}O₂ is used in a small amount or the cathode active materials are coated with other materials to thereby reform the cathode active materials.

In the meantime, the above technology in which the cathode active material is coated with other materials to thereby modify the cathode active material involves the problem as to the realization of high coatability. In order to solve this problem, various methods have been proposed. It has been confirmed that, for example, a method using a metal hydroxide to coat the cathode active material is superior in coatability. For example, JP-A NO. 9-265985 discloses that the surface of lithium nickelate LiNiO₂ particles is coated with cobalt Co and Mn through a process of coating the surface with hydroxides of these metals. Also, for example, JP-A NO. 11-71114 discloses that the surface of a lithium-manganese composite oxide is coated with a non-manganese metal through a process of coating the surface with a hydroxide of the non-manganese metal.

However, if heating treatment is performed after composite oxide particles are coated with a metal hydroxide, baking between particles easily proceeds, posing the problem that particles are easily bound among particles. As a result, when these composite oxide particles are mixed with a conductive agent when producing a cathode, the bound parts and particles are broken or cracked, with the result that the coating layer is peeled and the broken surface of particles is exposed. Such a broken surface has much higher activity than the surface formed in the baking process and tends to undergo a deterioration reaction between the electrolyte and the cathode active material.

It is therefore desirable to provide a cathode active material for nonaqueous electrolyte secondary battery which can further improve chemical stability by limiting the binding of particles among them, a method of producing the cathode active material and a nonaqueous electrolyte secondary battery which uses this cathode active material, has a high capacity and is superior in charge-discharge cycle characteristics.

### SUMMARY

According to an embodiment, there is provided a cathode active material for nonaqueous electrolyte secondary battery, the cathode active material comprising composite oxide particles containing at least lithium Li and cobalt Co, a coating layer disposed on at least a part of the surface of the above composite oxide particles and including an oxide containing lithium Li and at least one coating element selected from nickel Ni and manganese Mn, and a surface layer disposed on at least a part of the coating layer and including an oxide containing at least one element selected from among lanthanoids.

In the cathode active material for nonaqueous electrolyte secondary battery, the amount of elements adhered to the surface layer as the weight of lanthanoid oxide converted from the weight of lanthanoid of a metal oxide primarily containing an oxide containing at least an element selected from among lantanoids is preferably 0.02 parts by weight or more and 2.0 parts by weight or less with respect to 100 parts by weight of the cathode active material for nonaqueous electrolyte secondary battery.

Also, the composite oxide particles are preferably those having an average composition represented by the following formula:

Li₍₁₊ₓ₎Co_{(1-y)}MyO_{(2-z)} (Chemical formula 1)

wherein, M represents at least one element selected from the group consisting of magnesium Mg, aluminum Al, boron B, titanium Ti, vanadium V, chromium Cr, manganese Mn, iron Fe, nickel Ni, copper Cu, zinc Zn, molybdenum Mo, tin Sn, calcium Ca, strontium Sr, tungsten W, yttrium Y and zirconium Zr; and x, y and z satisfy the following relations: −0.10≦x≦0.10, 0≦y<0.50 and −0.10≦z≦0.20.

According to another embodiment, there is provided a method of producing a cathode active material for nonaqueous electrolyte secondary battery, the method comprising the steps of forming a layer including a hydroxide containing nickel and/or manganese Mn on at least a part of composite oxide particles containing at least lithium Li and cobalt Co and then, forming a layer including a hydroxide of at least one element selected from among lantanoids on at least a part of the composite oxide particles, and forming a coating layer including an oxide containing lithium Li and at least one coating element selected from nickel Ni and manganese Mn and a surface layer including an oxide of at least one element selected from among lanthanoids on at least a part of the composite oxide particles by heat treatment.

According to another embodiment, there is provided a method of producing a cathode active material for nonaqueous electrolyte secondary battery, the method comprising the steps of forming a layer including a hydroxide containing nickel and/or manganese Mn on at least a part of composite oxide particles containing at least lithium Li and cobalt Co, and coating the surface of the composite oxide particles with an oxide of at least one element selected from among lanthanoids and then, forming a coating layer including an oxide containing lithium Li and at least one coating element selected from nickel Ni and manganese Mn and a surface layer including an oxide of at least one element selected among lanthanoids on at least a part of the composite oxide particles by heat treatment.

According to another embodiment, there is provided a nonaqueous electrolyte secondary battery including a cathode having a cathode active material for aqueous electrolyte secondary battery, an anode and an electrolyte, wherein the cathode active material comprises composite oxide particles containing at least lithium Li and cobalt Co, a coating layer disposed on at least a part of the surface of the composite oxide particles and including an oxide containing lithium Li and at least one coating element selected from nickel Ni and manganese Mn, and a surface layer disposed on at least a part of the coating layer and including an oxide containing at least one element selected from among lanthanoids.

At least a part of composite oxide particles are provided with a coating layer including an oxide containing lithium Li and at least one coating element selected from nickel Ni and Mn. Therefore, high charge voltage characteristics and high-energy density characteristics along with these high-charge voltage characteristics can be realized and this secondary battery has favorable charge-discharge cycle characteristics under high-charge voltage conditions.

Also, a hydroxide containing at least one element selected from among lanthanoids is formed on composite oxide particles provided with a hydroxide containing at least one of nickel Ni and manganese Mn, to thereby suppress binding among particles and prevent the coating layer from being broken and the surface of the active composite oxide particles from being exposed by the breakdown of the coating layer.

Also, the uniformity of adhesion of the metal hydroxide to the surface of the composite oxide particles is improved.

Also, the breakdown on the coating layer that realizes high charge-discharge cycle characteristic while keeping a high battery capacity, to thereby prevent such a phenomenon that the surface of the composite oxide particles having high activity is exposed, causing the decomposition of the electrolyte and the elution of the surface of the composite oxide particles.

Accordingly, a nonaqueous electrolyte secondary battery can be obtained which is improved in the chemical stability of the cathode active material for nonaqueous electrolyte secondary battery make an improvement in functions and realizes a high battery capacity and charge-discharge cycle characteristics.

Additional features and advantages are described herein, and will be apparent from the following Detailed Description and the figures.

### BRIEF DESCRIPTION OF THE FIGURES

FIG. 1 is a schematic sectional view of a first example of a nonaqueous electrolyte secondary battery using a cathode active material according to an embodiment;

FIG. 2 is an enlarged sectional view of a part of a coiled electrode body shown in FIG. 1;

FIG. 3 is a schematic sectional view of a second example of a nonaqueous electrolyte secondary battery using a cathode active material according to an embodiment; and

FIG. 4 is an enlarged sectional view of a part of a battery element shown in FIG. 3.

### DETAILED DESCRIPTION

Embodiments will be explained with reference to the drawings. In a cathode active material for nonaqueous electrolyte secondary battery (hereinafter referred to as a cathode active material in some cases) in this embodiment, at least a part of composite oxide particles are provided with a coating layer including an oxide containing lithium Li and at least one coating element selected from nickel Ni and manganese Mn and at least a part of the coating layer is provided with a surface layer including an oxide containing a lanthanoid.

First, the reason why the cathode active material is made to have the above structure will be explained. A cathode active material primarily containing lithium cobalate LiCoO₂ can realize high-charge voltage characteristics and high-energy density characteristics along with these high-charge voltage characteristics. However, if a high-capacity charge-discharge cycle at high charge voltage is repeated, a reduction in capacity is not low. This is caused by the surface condition of the cathode active material particles and therefore, it is pointed out that the surface treatment of the cathode active material is necessary.

Though various surface treatments are therefore proposed, the surface treatment is carried out using a material that can restrain the reduction of the capacity or can contribute to the capacity from the viewpoint of preventing a reduction in capacity per volume or weight or limiting a reduction in capacity to the minimum, thereby making possible to realize high-charge voltage characteristics and high-energy density characteristics along with this high-voltage characteristic and also, to obtain a cathode active material superior in charge-discharge cycle characteristics at a high charge voltage.

It has benn found that when a cathode active material which is slightly deteriorated in high-charge voltage characteristics and in high-energy density characteristics along with this voltage characteristics and primarily contains lithium cobaltate LiCoO₂ is provided with a coating layer including an oxide containing lithium Li and at least one coating element selected from nickel Ni and manganese Mn, a cathode active material can be obtained which has high-charge voltage characteristics and high-energy density characteristics along with this voltage characteristics and is superior in high-capacity charge-discharge cycle characteristics under high-charge voltage conditions.

Examples of a method of disposing the coating layer on the composite oxide particles include a method in which a compound of lithium Li and a compound of nickel Ni and/or a compound of manganese Mn are pulverized to form microparticles, which are then mixed with the composite oxide particles in a dry system to thereby adhere the microparticles to the surface of the composite oxide particles. Moreover, the obtained composite oxide particles are baked to thereby form a coating layer including an oxide containing lithium Li and at least one coating element selected from nickel Ni and manganese Mn on the surface of the composite oxide particles. Also, a compound of lithium Li and a compound of nickel Ni and/or a compound of manganese Mn are dissolved and mixed in a solvent and the obtained solution is applied to adhere the microparticles to the surface of the composite oxide particles in a wet system, followed by baking to thereby form a coating layer including an oxide containing lithium Li and at least one coating element selected from nickel Ni and manganese Mn on the surface of the composite oxide particles. However, the result that these methods failed to obtain a highly uniform coating film was obtained.

It has also been found that nickel Ni and/or manganese Mn are adhered in the form of hydroxides to the composite oxide particles, which are then dehydrated under heating to form a coating layer, whereby a highly uniform coating film can be realized. This adhesion treatment is carried out to precipitate a hydroxide containing nickel Ni and/or manganese Mn on the surface of the composite oxide particles by dissolving a compound of nickel Ni and a compound of manganese Mn in a solvent system primarily containing water, then dispersing the composite oxide particles in this solvent system and by, for example, adding a base in this dispersion system to thereby improve the basicity of the dispersion system.

Moreover, it has been found that when this adhesion treatment is carried out in a solvent system primarily containing water having a pH of 12 or more, the uniformity of a coating film adhered to the composite oxide particles can be further improved. Specifically, metal composite oxide particles are dispersed in a solvent system primarily containing water having a pH of 12 or more in advance and a compound of nickel Ni and/or a compound of manganese Mn are added to the dispersion solution to thereby adhere a hydroxide containing nickel Ni and/or manganese Mn to the surface of the metal composite oxide particles.

Then, the composite oxide particles to which an hydroxide containing nickel Ni and/or manganese Mn is adhered by this adhesion treatment are dehydrated under heating to form a coating layer on the surface of the composite oxide particles. This ensures that the uniformity of the coating film on the surface of the composite oxide particles can be improved.

However, it has been found that the importance of the problem that the baking of particles among them easily proceeds in the baking of a precursor to which lithium Li is added, when the ratio of nickel Ni is increased and the ratio of manganese Mn is decreased in the composite oxide particles to which a hydroxide containing nickel Ni and/or manganese Mn is adhered.

When the baking of particles among them proceeds, a problem as explained below arises. In the formation of the cathode, it is necessary to increase the amount of mechanical energy to be supplied in particle crushing performed to uniformly mix the particles, a binder and carbon particles which are conductive agents. This is accompanied by the breakdown or destruction of the cathode active material including the composite oxide particles provided with the coating layer, leading to an increase in the amount of overall defects as powders.

In this case, the breakdown or destruction take place in the form of the rupture of binding portions among baked particles, formation of cracks of the particle itself, crushing of the particle itself or peeling of the coating layer. Particularly, in the composite oxide particles provided with the coating layer, the surface shape of the particle is not smoother than that of a particle such as the cathode active material primarily containing lithium cobaltate LiCoO₂ and the particle tends to have irregularities on the surface. For this reason, it is considered that when the particle catches external force, slippage of particles among them is inferior so that the external force is converged on a local area, with the result that the cathode active material is easily broken or destroyed.

As a result, the surface on which no coating layer is formed is exposed. Specifically, the surface, which exhibits no ability to improve the charge-discharge cycle characteristics, and a surface having no coating layer and active new surface, are exposed. Therefore, high-capacity charge-discharge cycle characteristics are deteriorated under high charge voltage condition. Here, as is known, the exposed surface is active and has a high surface energy. For this reason, the decomposition reaction of an electrolyte is high and also, the activity of the elution of the surface is much higher than that of the surface formed by ordinary baking.

Therefore, with regard to improving a deterioration in cathode ability caused by the baking of particles among them and production process, it has been found that the problem concerning the progress of baking can be improved by adhering a hydroxide containing at least one of lanthanoids including lanthanum La, cerium Ce, praseodymium Pr, neodymium Nd, promethium Pm, samarium Sm, europium Eu, gadolinium Gd, terbium Tb, dysprosium Dy, holmium Ho, erbium Er, thulium Tm, ytterbium Yb and lutetium Lu, to the surface of the composite oxide particles to which a hydroxide containing nickel Ni and and/or manganese Mn is adhered. Also, along with the improvement in the problem concerning the progress of baking, the breakdown and destruction of particles can be decreased. Also, it has been found that when the surface layer including metal oxide microparticles, nickel Ni and/or manganese Mn constituting the coating layer is prevented from being solved in the composite oxide particles as a solid solution to thereby retain nickel Ni and/or manganese Mn on the surface of the composite oxide particles, thereby increasing a coating effect, resulting in the improvement of cycle characteristics.

Next, the composite oxide particles, the coating layer and the surface layer will be explained.

### (Composite Oxide Particles)

The composite oxide particles contain at least lithium Li and cobalt Co and is preferably one having an average composition represented by the following formula. If such composite oxide particles are used, a high-capacity and high discharge potential can be obtained:

Li₍₁₊ₓ₎Co_{(1-y)}MyO_{(2-z)} (Chemical formula 1)

wherein, M represents at least one element selected from the group consisting of magnesium Mg, aluminum Al, boron B, titanium Ti, vanadium V, chromium Cr, manganese Mn, iron Fe, nickel Ni, copper Cu, zinc Zn, molybdenum Mo, tin Sn, calcium Ca, strontium Sr, tungsten W, yttrium Y and zirconium Zr; and x, y and z satisfy the following relations: −0.10≦x≦0.10, 0≦y<0.50 and −0.10≦z≦0.20.

Here, in the above formula, the range of x is −0.10≦x≦0.10, preferably −0.08≦x≦0.08, and more preferably −0.06≦x≦0.06. If x is less than the above range, discharge capacity is reduced. Also, if x exceeds the above range, lithium is diffused out of the particle, is a hindrance to the control of basicity in the next treating step and is finally a cause of a harmful effect on the promotion of the gelation of the cathode paste during kneading.

The range of y is 0≦y<0.50, preferably 0≦y<0.40, and more preferably 0≦y<0.30. When y exceeds the above range, high-charge voltage characteristics, which are the characteristics of LiCoO2 and high-energy density characteristics along with the voltage characteristics, are impaired.

The range of z is −0.10≦z≦0.20, preferably −0.08≦z≦0.18, and more preferably '0.06≦z≦0.16. If z is less than or exceeds the above range, discharge capacity tends to decrease.

As the composite oxide particles, a material usually available as the cathode active material may be used as starting material. Optionally, a material obtained after crushing secondary particles of the above cathode active material by, for example, a ball mill or a crusher may be used.

### (Coating Layer)

The coating layer is formed on at least a part of the composite oxide particles and includes an oxide containing lithium Li and at least one coating element selected from nickel Ni and manganese Mn. When this coating layer is disposed, high-charge voltage characteristics and high-energy density characteristics along with the above voltage characteristics can be realized and also, charge-discharge characteristics under high-charge voltage conditions can be improved.

The structural ratio of nickel Ni to manganese Mn in the coating layer is preferably in the following range: 100:0 to 30:70 and more preferably in the following range: 100:0 to 40:60. This is because when the amount of manganese Mn exceeds this range, the ability of absorbing lithium Li is deteriorated, which is finally a cause of a decrease in the capacity of the cathode active material and an increase in electric resistance when the coating layer is used in a battery. Also, this range of the structural ratio of nickel Ni to manganese Mn is the range where the progress of the baking of particles among them is limited, showing higher effectiveness, in the baking of a precursor to which lithium Li is added.

Also, a part of nickel Ni and manganese Mn in the oxide included in the coating layer may be each replaced with at least one metal element selected from the group consisting of magnesium Mg, aluminum Al, boron B, titanium Ti, vanadium V, chromium Cr, iron Fe, cobalt Co, copper Cu, zinc Zn, molybdenum Mo, tin Sn, calcium Ca, strontium Sr, tungsten W, yttrium Y and zirconium Zr.

This can improve the stability of the cathode active material and lithium ion-diffusibility. The amount of the selected metal element to be replaced is, for example, 40 mol % or less, preferably 30 mol % or less and more preferably 20 mol % or less with respect to the total amount of nickel Ni and manganese Mn in the oxide of the coating layer. This reason is that when the amount of the selected metal element to be replaced is increased, the ability of absorbing lithium Li is deteriorated, leading to a reduction in the capacity of the cathode active material.

The amount of the coating layer is, for example, 0.5 parts by weight or more and 50 parts by weight or less, preferably 1.0 parts by weight or more and 40 parts by weight or less and more preferably 2.0 parts by weight or more and 35 parts by weight or less with respect to 100 parts by weight of the composite oxide particles. This is because when the coating amount of the metal oxide is increased over this range, the capacity of the cathode active material is reduced. This is also because when the coating amount of the metal oxide is reduced below this range, the stability of the cathode active material is reduced.

### (Surface Layer)

The surface layer is provided on at least a part of the coating layer and includes an oxide of at least one element selected from among lanthanoids including lanthanum La, cerium Ce, praseodymium Pr, neodymium Nd, promethium Pm, samarium Sm, europium Eu, gadolinium Gd, terbium Tb, dysprosium Dy, holmium Ho, erbium Er, thulium Tm, ytterbium Yb and lutetium Lu.

The amount of the lanthanoid in the surface layer is 0.02 parts by weight or more and 2.0 parts by weight or less, preferably 0.05 parts by weight or more and 1.5 parts by weight or less and more preferably 0.1 parts by weight or more and 1.0 parts by weight or less as converted into the amount of lanthanoid oxide (for example, the weight obtained by converting the amount of lanthanum in the metal oxide into lanthanum oxide La₂O₃) with respect to 100 parts by weight of the cathode active material. When the amount of lanthanoid oxide to be adhered is increased over this range, there is a tendency that a resistance to the diffusion of lithium ions is increased and the capacity of the cathode active material is reduced. Also, when the amount of the lanthanoid oxide is reduced, there is a tendency that the effect of preventing the baking of particles among them and the effect of improving charge-discharge cycle characteristics along with the above effect are decreased.

The coating layer and the surface layer can be confirmed by examining a variation in the concentration of the element constituting the cathode active material toward the inside from the surface. This variation in the concentration may be measured by the measurement of the distribution of surface composition on the section or by a method in which the composition is measured by Auger Electron Spectroscopy; AES) or Secondary Ion Spectroscopy; SIMS) with cutting the cathode active material by, for example, sputtering. Also, the cathode active material may be slowly dissolved in an acidic solution to measure a variation in elution with time by Inductively Coupled Plasma Atomic Emission Spectroscopy (ICPAES) or the like.

The average particle diameter of the cathode active material constituted in the above manner is preferably 2.0 μm or more and 50 μm or less. This reason is that when the average particle diameter is less than 2.0 μm, the cathode active material is peeled off when it is pressed in the production of the cathode, and it is necessary to increase the amount of the conductive agent and the binder to be added because the surface area of the active material is increased, so that there is a tendency that the energy density per unit weight is decreased. This is also because when the average particle diameter exceeds 50 μm, there is a tendency that particles penetrate through the separator, causing short circuits to be developed.

(Production Method of a cathode Active Material)

Next, a method of producing a cathode active material according to an embodiment will be explained. A first production method and a second producing method will be explained below.

### <First Production Method>

A first method of producing a cathode active material according to a first embodiment is largely divided into a first step of forming a layer including a hydroxide containing nickel Ni and/or manganese Mn on at least a part of composite oxide particles and then, forming a layer including a hydroxide containing at least one of the above lanthanoids on at least a part of the composite oxide particles and a second step of forming a hydroxide containing at least one of the above lanthanoids and then heating to form a coating layer including an oxide containing lithium Li and at least one coating element selected from nickel Ni and manganese Mn, and a surface layer including an oxide containing at least one of the lanthanoids.

### (First Step)

In the first step, treatment for adhering a hydroxide containing nickel Ni and/or manganese Mn and a hydroxide containing at least one of lanthanoids is carried out. In the first step, for example, the composite oxide particles are dispersed in a solvent system primarily containing water in which a nickel Ni compound and/or manganese Mn compound are dissolved and then, for example, a base is added in this dispersion system to raise the basicity of the dispersion system, thereby precipitating an hydroxide containing nickel Ni and/or manganese Mn on the surface of the composite oxide particles. A method may be adopted in which the composite oxide particles are dispersed in a solvent primarily containing a basic water and then, a compound of nickel Ni and/or a compound of manganese Mn are added to this aqueous solution to thereby precipitate a hydroxide containing nickel Ni and/or manganese Mn.

As to the raw material used in the treatment for adhering a hydroxide containing nickel Ni, examples of the nickel compound which may be used include inorganic compounds such as nickel hydroxide, nickel carbonate, nickel nitrate, nickel fluoride, nickel chloride, nickel bromide, nickel iodide, nickel perchlorate, nickel bromate, nickel iodide, nickel oxide, nickel peroxide, nickel sulfide, nickel sulfate, nickel bisulfate, nickel nitride, nickel nitrite, nickel phosphate and nickel thiocyanate, and organic compounds such as nickel oxalate and nickel acetate. These compounds may be used alone or in combinations of two or more.

As to the raw material used in the treatment for adhering a hydroxide containing manganese Mn, examples of the manganese compound which may be used include inorganic compounds such as manganese hydroxide, manganese carbonate, manganese nitrate, manganese fluoride, manganese chloride, manganese bromide, manganese iodide, manganese chlorate, manganese perchlorate, manganese bromate, manganese iodide, manganese oxide, manganese peroxide, manganese phosphinate, manganese sulfide, manganese hydrogen sulfide, manganese nitrite, manganese hydrogensulfate, manganese thiocyanate, manganese nitrite, manganese phosphate, manganese dihydrogenphsphate and manganese hydrogen carbonate and organic compounds such as manganese oxalate and manganese acetate. These compounds may be used alone or in combinations of two or more.

Next, a hydroxide containing at least one of lanthanoids is adhered to the surface of the composite oxide particles to which a hydroxide containing nickel Ni and/or manganese Mn is adhered. The adhesion of a hydroxide containing at least one of lanthanoids may be carried out in the same manner as in the case of the adhesion of a hydroxide containing nickel Ni and/or manganese Mn. Specifically, the composite oxide particles to which a hydroxide containing nickel Ni and/or manganese Mn is adhered are dispersed in a solvent system primarily containing water in which a compound containing at least one of lanthanoids is dissolved, and a base is added in this dispersion system to raise the basicity of the dispersion system, thereby precipitating a hydroxide containing at least one of lanthanoids. In this case, a method may be adopted in which the composite oxide particles to which a hydroxide containing nickel Ni and/or manganese Mn is adhered are dispersed in a solvent primarily containing basic water, and then, a compound containing at least one of lanthanoids is added to this aqueous solution to precipitate the hydroxide.

As the raw material of used in the adhesion treatment using a hydroxide containing at least one of lanthanoids, the following compounds may be used.

As the lanthanum compound, inorganic compounds such as lanthanum nitrate, lanthanum fluoride, lanthanum chloride, lanthanum bromide, lanthanum iodide, lanthanum perchlorate, lanthanum oxide, lanthanum sulfate and lanthanum carbonate, or organic compounds such as lanthanum oxalate and lanthanum acetate may be used. These compounds may be used alone or in combinations of two or more.

As the cerium compound, inorganic compounds such as cerium nitrate, cerium fluoride, cerium chloride, cerium bromide, cerium iodide, cerium perchlorate, cerium oxide, cerium sulfate and cerium carbonate or inorganic compounds cerium oxalate and cerium acetate may be used. These compounds may be used alone or in combinations of two or more.

As the praseodymium compound, inorganic compounds such as praseodymium nitrate, praseodymium fluoride, praseodymium chloride, praseodymium bromide, praseodymium iodide, praseodymium perchlorate, praseodymium oxide, praseodymium sulfate and praseodymium carbonate or organic compounds praseodymium oxalate and praseodymium acetate may be used. These compounds may be used alone or in combinations of two or more.

As the neodymium compound, inorganic compounds such as neodymium nitrate, neodymium fluoride, neodymium chloride, neodymium bromide, neodymium iodide, neodymium perchlorate, neodymium oxide, neodymium sulfate and neodymium carbonate or organic compounds such as neodymium oxalate and neodymium acetate may be used. These compounds may be used alone or in combinations of two or more.

As the samarium compound, inorganic compounds such as samarium nitrate, samarium fluoride, samarium chloride, samarium bromide, samarium iodide, samarium perchlorate, samarium oxide, samarium sulfate and samarium carbonate or organic compounds samarium oxalate and samarium acetate may be used. These compounds may be used alone or in combinations of two or more.

As the europium compound, inorganic compounds such as europium nitrate, europium fluoride, europium chloride, europium bromide, europium iodide, europium perchlorate, europium oxide, europium sulfate and europium carbonate or organic compounds europium oxalate and europium acetate may be used. These compounds may be used alone or in combinations of two or more.

As the gadolinium compound, inorganic compounds such as gadolinium nitrate, gadolinium fluoride, gadolinium chloride, gadolinium bromide, gadolinium iodide, gadolinium perchlorate, gadolinium oxide, gadolinium sulfate and gadolinium carbonate or organic compounds gadolinium oxalate and gadolinium acetate may be used. These compounds may be used alone or in combinations of two or more.

As the terbium compound, inorganic compounds such as terbium nitrate, terbium fluoride, terbium chloride, terbium bromide, terbium iodide, terbium perchlorate, terbium oxide, terbium sulfate and terbium carbonate or organic compounds terbium oxalate and terbium acetate may be used. These compounds may be used alone or in combinations of two or more.

As the dysprosium compound, inorganic compounds such as dysprosium nitrate, dysprosium fluoride, dysprosium chloride, dysprosium bromide, dysprosium iodide, dysprosium perchlorate, dysprosium oxide, dysprosium sulfate and dysprosium carbonate or organic compounds dysprosium oxalate and dysprosium acetate may be used. These compounds may be used alone or in combinations of two or more.

As the holmium compound, inorganic compounds such as holmium nitrate, holmium fluoride, holmium chloride, holmium bromide, holmium iodide, holmium perchlorate, holmium oxide, holmium sulfate and holmium carbonate or organic compounds holmium oxalate and holmium acetate may be used. These compounds may be used alone or in combinations of two or more.

As the erbium compound, inorganic compounds such as erbium nitrate, erbium fluoride, erbium chloride, erbium bromide, erbium iodide, erbium perchlorate, erbium oxide, erbium sulfate and erbium carbonate or organic compounds erbium oxalate and erbium acetate may be used. These compounds may be used alone or in combinations of two or more.

As the thulium compound, inorganic compounds such as thulium nitrate, thulium fluoride, thulium chloride, thulium bromide, thulium iodide, thulium perchlorate, thulium oxide, thulium sulfate and thulium carbonate or organic compounds thulium oxalate and thulium acetate may be used. These compounds may be used alone or in combinations of two or more.

As the ytterbium compound, inorganic compounds such as ytterbium nitrate, ytterbium fluoride, ytterbium chloride, ytterbium bromide, ytterbium iodide, ytterbium perchlorate, ytterbium oxide, ytterbium sulfate and ytterbium carbonate or organic compounds ytterbium oxalate and ytterbium acetate may be used. These compounds may be used alone or in combinations of two or more.

As the lutetium compound, inorganic compounds such as lutetium nitrate, lutetium fluoride, lutetium chloride, lutetium bromide, lutetium iodide, lutetium perchlorate, lutetium oxide, lutetium sulfate and lutetium carbonate or organic compounds lutetium oxalate and lutetium acetate may be used. These compounds may be used alone or in combinations of two or more.

In the first step, the above solvent system primarily containing water has a pH of, for example 12 or more, preferably 13 or more and more preferably 14 or more. As the pH of the above solvent system primarily containing water is higher, the uniformity of the adhesion of a hydroxide containing nickel Ni and/or manganese Mn is better and the accuracy of the reaction is higher, bringing about the advantages that the productivity is improved due to a reduction in treating time and the quality is improved. The pH of the solvent system primarily containing water may be adjusted depending on the cost of an alkali.

The temperature of dispersion system is, for example, 40° C. or higher, preferably 60° C. or higher, more preferably 80° C. or higher. As the temperature of the dispersion is higher, the uniformity of the adhesion of a hydroxide containing nickel Ni and/or manganese Mn is better, and the reaction speed is higher, bringing about the advantages that the productivity is improved due to a reduction in treating time and the quality is improved. Although the cost and productivity concerning the device are considered, a method in which an autoclave is used to undergo a reaction at 100° C. or more may be recommended from the viewpoint of improving the uniformity of adhesion and improving the reaction rate to thereby reduce the treating time.

Moreover, in the first step, a hydroxide containing at least one of lanthanoids can be adhered by, for example, forming a hydroxide containing nickel Ni and/or manganese Mn on the surface of the composite oxide particles by using a solvent system primarily containing water, and then by taking the composite oxide particles out of the solvent system primarily containing water, though the present disclosure is not limited to this method. For example, a hydroxide containing at least one of lanthanoids can be adhered by, for example, forming a hydroxide containing nickel Ni and/or manganese Mn on the surface of the composite oxide particles and a compound including a lanthanoid is added in this solvent system kept as it is without separating the composite oxide particles from the solvent system primarily containing water.

Moreover, the pH of the solvent system primarily containing water may be adjusted by dissolving an alkali in the solvent system primarily containing water. Examples of the alkali may include lithium hydroxide, sodium hydroxide and potassium hydroxide and mixtures of these compounds. These alkalis may be properly used to carry out the process. It is however preferable to use lithium hydroxide from the viewpoint of the purity and performance of the cathode active material finally obtained according to an embodiment. This is because of the advantage that the amount of lithium in the cathode active material finally obtained according to an embodiment can be controlled by controlling the amount of the adhered dispersion medium including a solvent primarily containing water when the composite oxide particles formed with a hydroxide containing nickel and/or manganese Mn are taken out of the solvent system primarily containing water.

### (Second Step)

In the second step, the composite oxide particles which has been subjected to adhesion treatment in the first step are separated from the solvent system primarily containing water and then, heat-treated to dehydrate the hydroxide, thereby forming a coating layer including an oxide containing lithium Li and at least one coating element selected from nickel Ni and manganese Mn and surface layer including an oxide containing at least one of lanthanoids on the surface of the composite oxide particles. Here, the heat treatment is preferably performed at a temperature of, for example, about 300° C. to 1000° C. in an oxidizing atmosphere such as air or pure oxygen. At this time, a hydroxide containing at least one type selected among lanthanoids is adhered to the hydroxide containing nickel Ni and manganese Mn and therefore, the baking of particles among them is limited, so that binding of particles among them is suppressed.

After the composite oxide particles subjected to the adhesion treatment in the first step are separated from the solvent system primarily containing water, the composite oxide particles may be made to be impregnated with an aqueous solution of a lithium compound to adjust the amount of lithium according to the need, followed by heat treatment.

As the lithium compound, inorganic compounds such as lithium hydroxide, lithium carbonate, lithium nitrate, lithium fluoride, lithium chloride, lithium bromide, lithium iodide, lithium chlorate, lithium perchlorate, lithium bromate, lithium iodate, lithium oxide, lithium peroxide, lithium sulfide, lithium hydrogensulfide, lithium sulfate, lithium hydrogensulfate, lithium nitride, lithium azide, lithium nitrate, lithium phosphate, lithium dihydrogenphosphate and lithium bicarbonate or organic compounds such as methyl lithium, vinyl lithium, isopropyl lithium, butyl lithium, phenyl lithium, lithium oxalate and lithium acetate may be used.

Also, after baked, the grain size of the composite oxide particles may be adjusted by light milling or classifying operations.

### <Second Production Method>

A second method of producing a cathode active material according to an embodiment may be largely divided into a first step of forming a layer including a hydroxide containing nickel Ni and/or manganese Mn on at least a part of the composite oxide particles, followed by drying, a second step of coating at least a part of the dried composite oxide particles with metal oxide microparticles including an oxide containing at least one of lanthanoids and a third step of heat-treating the composite oxide particles coated with the metal oxide particles to form a coating layer including an oxide containing lithium Li and at least one coating element selected from nickel Ni and manganese Mn and a surface layer including an oxide containing at least one of lanthanoids on at least a part of the composite oxide particles.

### (First Step)

In the first step, treatment for adhering a hydroxide containing nickel Ni/or manganese Mn to the surface of the composite oxide particles. In the hydroxide adhesion treatment, the same materials and method that are used in the first production method may be used. Next, the composite oxide particles with a hydroxide adhered thereto are separated from the solvent system primarily containing water and then, dried at, for example, 120° C.

### (Second Step)

In the second step, metal oxide microparticles including an oxide containing at least one of lanthanoids are added to the composite oxide particles with a hydroxide adhered thereto in the first step, followed by mixing with stirring in a dry system to coat the surface of the composite oxide particles with the metal oxide particles.

### (Third Step)

In the third step, the composite oxide particles coated with the metal oxide particles after an hydroxide is made to adhere thereto are heat-treated to dehydrate the hydroxide, thereby forming a coating layer including an oxide containing lithium Li and at least one coating element selected from nickel Ni and manganese Mn and a surface layer including an oxide containing at least one of lanthanoids on the surface of the composite oxide particles. Here, the heat-treatment is preferably carried out at a temperature of, for example, about 300° C. to 1000° C. in an oxidizing atmosphere, for example, an air or oxygen atmosphere. At this time, since the metal oxide particles containing at least one of lanthanoids are adhered to the hydroxide containing nickel Ni and/or manganese Mn, baking of particles among them is limited and binding of particles among them is therefore suppressed.

In this case, after baked, the grain size of the composite oxide particles may be adjusted by light milling or classifying operations in the same manner as in the first production method.

The use of such a cathode active material ensures that high stability can be obtained under a high charge voltage, and along with this, high-energy density characteristics and high charge-discharge capacity can be obtained. Also, a nonaqueous electrolyte secondary battery superior in charge-discharge cycle characteristics under high-charge voltage conditions can be obtained.

Next, a nonaqueous electrolyte secondary battery using a cathode active material according to an embodiment will be explained.

### (1) First Example of a Nonaqueous Electrolyte Secondary Battery

### (1-1) Structure of a Nonaqueous Electrolyte Secondary Battery

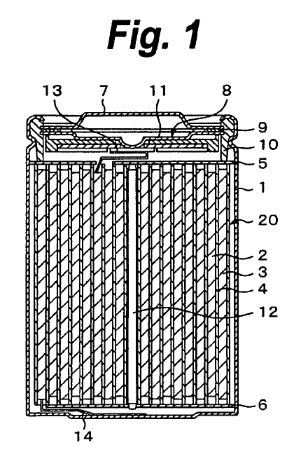

FIG. 1 shows the sectional structure of a nonaqueous electrolyte secondary battery using a cathode active material according to an embodiment.

In this secondary battery, the open-circuit voltage per paired cathode and anode in a fully charged state is, for example, 4.25 V or higher and 4.65 V or lower.

This secondary battery which is the so-called cylinder type is provided with a coiled electrode body 20 in which a band-type cathode 2 and a band-like anode 3 are coiled with a separator 4 interposed therebetween in a battery can 1 having an almost hollow columnar form.

The battery can 1 is constituted of iron Fe plated with nickel Fe, and one end of the battery can I is closed and the other is opened. A pair of insulation plates 5 and 6 is respectively disposed perpendicularly to the coil peripheral surface in such a manner as to sandwich the coiled electrode body 20 inside of the battery can 1.

A battery lid 7, and a safety valve mechanism 8 and a heat-sensitive resistance element (positive temperature coefficient element) 9 which are disposed inside of the battery lid 7 are set to the open end of the battery can 1 with a gasket 10 interposed therebetween by caulking, and the battery can 1 is sealed. The battery lid 7 is constituted of the same material as the battery can 1. The safety valve mechanism 8 is electrically connected to the battery lid 7 through the heat-sensitive element 9 in such a manner that when the internal pressure of the battery is over a fixed level caused by the development of short circuits or heating from the outside, a disk plate 11 is reversed to cut electrical connection between the battery lid 7 and the coiled electrode body 20. The heat-sensitive resistance element 9 serves to limit current by increasing the resistance when the temperature is raised to prevent abnormal heat generation caused by large current. The gasket 10 is constituted of, for example, an insulation material and its surface is coated with asphalt.

The coiled electrode body 20 is, for example, coiled on the center of a center pin 12. A cathode lead 13 made of aluminum Al is connected with the cathode 2 of the coiled electrode body 20, and an anode lead 14 made of nickel Ni is connected with the anode 3. The cathode lead 13 is bound with the safety valve mechanism 8 by welding whereby it is electrically connected to the battery lid 7 and the anode 14 is bound with the battery can 1 by welding whereby it is electrically connected to the battery can 1.

### (Cathode)

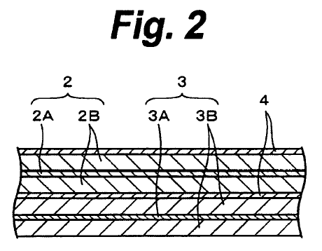

FIG. 2 shows an enlarged view of a part of the coiled electrode body 20 shown in FIG. 1. As shown in FIG. 2, the cathode 2 is provided with a cathode current collector 2A having a pair of surfaces opposite to each other and a cathode composite layer 2B formed on each side of the cathode current collector 2A. In this case, the cathode may have a structure in which it has an area where the cathode composite layer 2B is provided only on one surface of the cathode current collector 2A. The cathode current collector 2A is constituted of a metal foil such as an aluminum Al foil. The cathode composite layer 2B contains, for example, a cathode active material and may contain a conductive agent such as graphite and a binder such as polyvinylidene fluoride according to the need. As the cathode active material, the cathode active material in the aforementioned embodiment may be used.

### (Anode)

As shown in FIG. 2, the anode 3 is provided with an anode current collector 3A having a pair of surfaces opposite to each other and an anode composite layer 3B formed on each side of the anode current collector 3A. In this case, the anode may have a structure in which it has an area where the anode composite layer 3B is provided only on one surface of the anode current collector 3A. The anode current collector 3A is constituted of a metal foil such as a copper Cu foil. The anode composite layer 3B contains, for example, an anode active material and may contain a binder such as polyvinylidene fluoride according to the need.

As the anode active material, an anode material (hereinafter, optionally referred to as an anode material which can absorb or release lithium Li), which can absorb or release lithium Li, is contained. Examples of the anode material, which can absorb or release lithium Li, include carbon materials, metal compounds, oxides, sulfides, lithium nitrides such as LiN₃, lithium metals, metals forming alloys with lithium or polymer materials.

Examples of the carbon material include non-easy-graphitizable carbon, easy-graphitizable carbon, graphite, thermally decomposed carbons, cokes, glass carbons, organic polymer compound sintered body, carbon fibers and activated carbon. Examples of the cokes among these materials include pitch cokes, needle cokes and petroleum cokes. The organic polymer sintered body means materials obtained by sintering polymer materials such as phenol resins and furan resins at an appropriate temperature to carbonize and a part thereof includes those classified into carbons difficult to be converted into graphite and carbons easy to be converted into graphite. Also, examples of the polymer material include a polyacetylene and polypyrrole.

Among these anode materials which can absorb and release lithium Li, those having a charge-discharge potential relatively close to that of a lithium metal are desirable. This is because the energy density of the battery is made higher more easily as the charge-discharge potential of the anode 3 is lower. Particularly, carbon materials are preferable because they are very limited in a variation in crystal structure caused during charge-discharge operations and therefore, high charge-discharge capacity can be obtained and enable favorable cyclic characteristics. Particularly, graphite has a high electrochemical equivalent and enables high energy density and is therefore desirable. Also, above non-easy-graphitizable carbon is desirable because excellent cycle characteristics can be obtained.

Examples of the anode material which can absorb and release lithium Li also include single lithium metals, metal elements, single semi-metal elements, alloys or compounds which can form alloys with lithium Li. These materials are preferable because high energy density can be obtained. Particularly, if these materials are used in combination of a carbon material, this is preferable because high energy density is obtained and also, excellent cycle characteristics can be obtained. In this specification, the alloy includes, besides those containing two or more metal elements, and those constituted of one or more metal elements and one or more semi-metal elements. Examples of the organization of the alloy include solid solutions, eutectic crystals (eutectic mixtures), intermetallic compounds and those in which two or more of these materials coexist.

Examples of such a metal element or semi-metal element include tin Sn, lead Pb, aluminum Al, indium In, silicon Si, zinc Zn, antimony Sb, bismuth Bi, cadmium Cd, magnesium Mg, boron B, gallium Ga, germanium Ge, arsenic As, silver Ag, zirconium Zr, yttrium Y and hafnium Hf. Examples of the alloys or compounds of these elements include those represented by the chemical formula MeₛMfₜLiᵤ or MeₚMg_{q}Mₕᵣ. In these chemical formulae, Me represents at least one type selected from among metal elements and semi-metal elements which can form an alloy with lithium, Mf represents at least one type selected from among metal elements and semi-metal elements other than lithium and Me, Mg represents at least one type selected from among non-metal elements and Mh represents at least one type selected from among metal elements and semi-metal elements other than Me. Also, s, t, u, p, q and r respectively satisfy the following requirements: s>0, t≧0, u≧0, p>0, q>0 and r≧0.

Among these materials, simple metals, alloys or compounds of the 4B group metal elements in the short-formed periodic chart, semi-metal elements are preferable and silicon Si and tin Sn or alloys or compounds of these elements are more desirable. These materials may be crystal types or amorphous types.

Other than above, inorganic compounds containing no lithium Li such as MnO₂, V₂O₅, V₆O₁₃, NiS and MoS may be used.

### (Electrolytic Solution)

As the electrolytic solution, a nonaqueous electrolytic solution in which an electrolytic salt is dissolved in a nonaqueous solvent may be used. The nonaqueous solvent preferably contains at least one of ethylene carbonate and propylene carbonate. This is because cycle characteristics can be improved. Particularly, when a mixture of these carbonates is contained, this is preferable because the cycle characteristics can be improved. The nonaqueous solvent preferably contains at least one type selected from among chain carbonates such as diethyl carbonate, dimethyl carbonate, ethylmethyl carbonate and methylpropyl carbonate. This is because the cycle characteristics can be further improved.

The nonaqueous solvent preferably further contains at least one of 2,4-difluoroanisole and vinylene carbonate. This is because 2,4-difluoroanisole can improve discharge capacity and vinylene carbonate can further improve the cycle characteristics. Particularly, a mixture of these compounds is more preferable because the discharge capacity and cycle characteristics can be both improved.

The nonaqueous solvent may include one or two or more types selected from among butylene carbonate, γ-butyrolactone and γ-valerolactone, compounds obtained by substituting a part or all of the hydrogen groups of these compounds with a fluorine group, 1,2-dimethoxyethane, tetrahydrofuran, 2-methyltetrahydrofuran, 1,3-dioxoran, 4-methyl-1,3-dioxoran, methyl acetate, methyl propionate, acetonitrile, glutaronitrile, adiponitrile, methoxyacetonitrile, 3-methoxypropylonitrile, N,N-dimethylformamide, N-methylpyrrolidinone, N-methyloxazolidinone, N,N-dimethylimidazolidinone, nitromethane, nitroethane, sulfolane, dimethyl sulfoxide and trimethylphosphate.

There may be the case where the reversibility of the electrode reaction is improved by using a compound obtained by substituting a part or all of the hydrogen atoms of the material included in the above nonaqueous solvent group with a fluorine atom though depending on the electrodes to be combined. Therefore, these materials may be optionally used.

Examples appropriate as the lithium salt which is the electrolytic salt include lithium hexafluorophosphate LiPF₆, lithium tetrafluoroborate LiBF₄, lithium hexafluoroarsenate LiAsF₆, lithium perchlorate LiClO₄, lithium tetraphenylborate LiB(C₆H₅)₄, lithium methanesulfonate LiCH₃SO₃, lithium trifluoromethanesulfonate LiCF₃SO₃, bis(trifluoromethanesulfonyl)imidelithium LiN(SO₂CF₃)₂, tris(trifluoromethanesulfonil), methyllithium LiC(SO₂CF₃)₂, lithium tetrachloroaluminate LiAlCl₄, lithium hexafluorosilicate LiSiF₆, lithium chloride LiCl, lithium difluorooxalate-borate LiBF₂(ox), lithium bisoxalate-borate LiBOB and lithium bromide LiBr. These compounds may be used alone or as a mixture of two or more. Among these compounds, LiPF₆ is preferable because it can provide high ion conductivity and can improve the cycle characteristics.

### (Separator)

The material used for the separator 4 usable according to an embodiment will be explained below. As the separator 4, the materials used in current batteries may be utilized. Among these materials, a polyolefin microporous film is preferably used because it is superior in the effect of preventing short circuits and can improve the safety of the battery due to the shutdown effect. A microporous film made of a polyethylene PE or polypropylene PP is preferable.

Moreover, it is preferable to use that obtained by laminating or mixing a polyethylene having a lower shutdown temperature and a polypropylene superior in anti-oxidation characteristics from the viewpoint of realizing shutdown performances and float characteristics at the same time.

### (1-2) Method of Producing a Nonaqueous Electrolyte Secondary Battery

Next, a method of producing a nonaqueous electrolyte secondary battery will be explained. A method of producing a nonaqueous electrolyte secondary battery will be explained taking a cylinder type nonaqueous electrolyte secondary battery as an example.

The cathode 2 is produced in the manner explained below. First, for example, a cathode active material, a conductive agent and a binder are mixed to prepare a cathode composite material, which is then dispersed in a solvent such as N-methyl-2-pyrrolidone to make a cathode composite slurry.

Next, this cathode composite slurry is applied to the cathode current collector 2A, followed by drying to remove the solvent and then, compression-molded by a roll press machine to form a cathode composite layer 2B, thereby producing the cathode 2.

The anode 3 is produced in the manner explained below. First, for example, an anode active material and a binder are mixed to prepare an anode composite material, which is then dispersed in a solvent such as N-methyl-2-pyrrolidone to make an anode composite slurry.

Next, this anode composite slurry is applied to the anode current collector 3A, followed by drying to remove the solvent and then, compression-molded by a roll press machine to form an anode composite layer 3B, thereby producing the anode 3.

Also, the anode composite layer 3B may be formed by a vapor phase method, liquid phase method, or baking method and these methods may be used in combinations of two or more. As the vapor phase method, a physical sedimentation method or chemical sedimentation method may be used. Specifically, a vacuum vapor deposition method, sputtering method, ion-plating method, laser abrasion method, thermal CVD (Chemical Vapor Deposition; chemical vapor phase growth) method or plasma CVD method may be utilized. As the liquid phase method, known measures such as electrolytic plating or electroless plating may be utilized. As the baking method, known methods may be utilized and, for example, an atmospheric baking method, reaction baking method or hot-press baking method may be utilized.

Next, the cathode lead 13 is attached to the cathode current collector 2A by welding and also, the anode lead 14 is attached to the anode current collector 3A by welding. Then, the cathode 2 and the anode 3 are coiled with the separator 4 interposed therebetween. Then, the end part of the cathode lead 13 is secured to the safety valve mechanism 8 by welding and also, the end of the anode lead 14 is secured to the battery can 1 by welding. Then, the coiled cathode 2 and the anode 3 are sandwiched between a pair of insulation plates 5 and 6 and received in the battery can 1.

Next, the electrolytic solution is injected into the battery can 1 to impregnate the separator 4 with the electrolytic solution. Next, the battery lid 7, safety valve mechanism 8 and heat-sensitive resistance element 9 are secured to the opening end of the battery can 1 with the gasket 10 interposed therebetween by caulking. Thus, the nonaqueous electrolyte secondary battery is produced.

### (2) Second Example of the Nonaqueous Electrolyte Secondary Battery

### (2-1) Structure of a Nonaqueous Electrolyte Secondary Battery

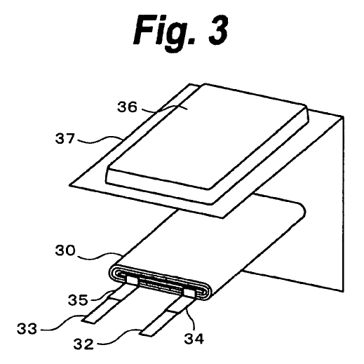

FIG. 3 shows the structure of a nonaqueous electrolyte secondary battery using a cathode active material obtained according to an embodiment. As shown in FIG. 3, this nonaqueous electrolyte secondary battery is produced by putting a battery element 30 into an outer package material 37 made of a moisture-proofing laminate film and sealing the periphery of the battery element 30 by deposition. The battery element 30 is provided with a cathode lead 32 and an anode 33 and these leads are drawn out of the package in the condition they are sandwiched between the outer package 37. The cathode lead 32 and anode lead 33 are respectively provided with resin fragments 34 and 35, which are applied to both surfaces to improve the adhesion of the electrode leads to the outer package material 37.

### (Outer Package Material)

The outer package material 37 has a laminate structure in which an adhesive layer, a metal layer and a surface protective layer are laminated one by one. The adhesive layer is made of a polymer film and examples of the material constituting the polymer film include a polypropylene PP, polyethylene PE, casted polypropylene CPP, linear low-density polyethylene LLDPE and low-density polyethylene LDPE. The metal layer is made of a metal foil and examples of the material constituting this metal foil include aluminum Al. Also, as the material constituting the metal foil, metals other than aluminum Al may be used. Examples of the material constituting the surface protective layer include nylon Ny and polyethylene terephthalate PET. In this case, the surface on the adhesive layer side is the receiving surface on the side receiving the battery element 30.

### (Battery Element)

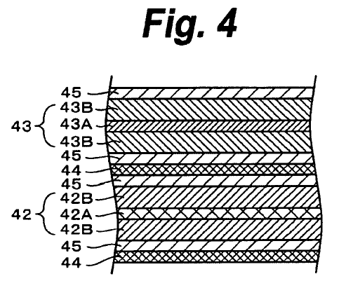

This battery element 30 is a coil type battery element in which as shown in FIG. 4, a band-like anode 43 with a gel electrolyte layer 45 formed on each side thereof, a separator 44, a band-like cathode 42 with a gel electrolyte layer 45 formed on each side thereof and a separator 44 are laminated and coiled in the longitudinal direction.

The cathode 42 is provided with a band-like cathode current collector 42A and a cathode composite layer 42B formed on each side of the cathode current collector 42A.

At the one end of the cathode 42 in its longitudinal direction is provided with a cathode lead 32 connected to this end by, for example, spot welding or ultrasonic welding. As the material of this cathode lead 32, a metal, for example, aluminum may be used.

The anode 43 is provided with a band-like anode current collector 43A and an anode composite layer 43B formed on each side of the anode current collector 43A.

At the one end of the anode 43 in its longitudinal direction is provided with an anode lead 33 connected to this end by, for example, spot welding or ultrasonic welding. As the material of this anode lead 33, for example, copper Cu or nickel Ni may be used.

The cathode current collector 42A, cathode composite layer 42B, anode current collector 43A and anode composite 43B are the same as those in the first example.

The gel electrolyte layer 45 includes an electrolytic solution and a polymer compound which is to be a support body retaining this electrolytic solution and has the so-called gel form. The gel electrolyte layer 45 is desirable because it can provide high ion conductivity and prevent liquid leakage from the battery. The structure of the electrolytic solution (specifically, a liquid solvent and an electrolytic salt) is the same as that used in the first embodiment.

Examples of the polymer compound may include a polyacrylonitrile, polyvinylidene fluoride, copolymer of vinylidene fluoride and hexafluoropropylene, polytetrafluoroethylene, polyhexafluoropropylene, polyethylene oxide, polypropylene oxide, polyphosphazene, polysiloxane, polyvinyl acetate, polyvinyl alcohol, methyl polymethacrylate, polyacrylic acid, polymethacrylic acid, styrene-butadiene rubber, nitrile-butadiene rubber, polystyrene and polycarbonate. A polyacrylonitrile, polyvinylidene fluoride, polyhexafluoropropylene and polyethylene oxide are preferable from the viewpoint of, particularly, electrochemical stability.

### (2-2) Method of Producing a Nonaqueous Electrolyte Secondary Battery

Next, a method of producing a nonaqueous electrolyte secondary battery using a cathode active material according to an embodiment will be explained. First, a precursor solution containing a solvent, an electrolytic salt, a polymer compound and a mixture solvent is applied to each of the cathode 42 and anode 43, and then, the mixture solvent is vaporized to form a gel electrolyte layer 45. In this case, a cathode lead 32 is attached to the end of the cathode current collector in advance by welding and an anode 33 is attached to the end of the anode current collector 43A in advance by welding.

Next, the cathode 42 and anode 43 each formed with the gel electrolyte layer 45 are laminated with the separator 44 interposed therebetween to form a laminate, which is then coiled in its longitudinal direction to form a coil type battery element 30.

Next, the outer package material 37 made of a laminate film is processed by deep drawing to form a concave portion 36 and then, the battery element 30 is inserted into the concave portion 36. Then, the unprocessed part of the outer package material 37 is folded so as to cover the upper part of the concave portion 36 and then, the outside peripheral part of the concave portion 36 is sealed by thermal deposition. Thus, a nonaqueous electrolyte secondary battery is produced.

### EXAMPLES

The present embodiments will be explained in detail by way of examples with reference to the drawings. However, the present embodiments are not limited to the examples described below.

### Example 1

First, a method of producing a cathode active material used in this embodiment is shown below.

100 parts by weight of lithium cobaltate (average chemical composition analytical value: Li_{1.03}CoO_{2.02}) having an average particle diameter of 13 μm and a specific surface area of 0.3 m²/g was dispersed in 3000 parts by weight of an aqueous 2 N lithium hydroxide LiOH solution under stirring at 80° C. for one hour. A solution prepared by dissolving 11.15 parts by weight of nickel nitrate Ni(NO₃)₂.6H₂O which was a commercially available reagent and 3.67 parts by weight of manganese nitrate Mn(NO₃)₂.6H₂O which was a commercially available reagent in 100 parts by weight of purified water was added to the above dispersion solution over 2 hours. Moreover, a solution prepared by dissolving 1.33 parts by weight of lanthanum nitrate La(NO₃)₃.6H₂O which was a commercially available reagent in 50 parts by weight of purified water was added to the dispersion solution over one hour and then, the mixture was dispersed at 80° C. with stirring for one hour, followed by stirring continuously at 80° C. for one hour and then, the resulting mixture was allowed to cool. 100 parts by weight of a precursor sample obtained by filtering this dispersion system and drying the residue at 120° C. was impregnated with 25 parts by weight of the above aqueous 2 N lithium hydroxide LiOH solution to control the amount of lithium and uniformly dispersed, followed by drying to obtain a baking precursor. This baking precursor was heated at a rate of 5° C./min. in an electric furnace, then kept at 950° C. for 5 hours and cooled to 150° C. at a rate of 7° C./min., to obtain a cathode active material.

Using the above cathode active material, a cylinder type secondary battery was produced as shown below.

First, 86% by weight of the produced cathode active material powder, 10% by weight of graphite as a conductive agent and 4% by weight of a polyvinylidene fluoride PVdF as a binder were mixed and the mixture was dispersed in N-methyl-2-pyrrolidone NMP used as a solvent. Then, the dispersion solution was applied to both surfaces of a cathode current collector made of a band-like aluminum foil 20 μm in thickness and then dried, followed by compression-molding using a roller press machine to form a cathode composite layer, thereby producing a cathode. At this time, the cathode active material powder was sufficiently crushed by a crusher such that it passed through a 70 μm opening screen prior to use. The voids of the cathode composite layer were adjusted to 26% in terms of volume ratio. Next, a cathode lead made of aluminum was attached to the cathode current collector.

Also, 90% by weight of an artificial graphite powder as an anode active material and 10% by weight of a polyvinylidene fluoride PVdF as a binder were mixed and the mixture was dispersed in N-methyl-2-pyrrolidone NMP used as a solvent. Then, the dispersion solution was applied to both surfaces of an anode current collector made of a band-like copper foil 10 μm in thickness and then dried, followed by compression-molding using a roller press machine to form an anode composite layer, thereby producing an anode. Next, an anode lead made of nickel was attached to the anode current collector.

The band-like cathode and band-like anode produced in the above manner were laminated with a porous polyolefin film separator interposed therebetween and wound in the form of a coil having many turns to produce a spiral type coiled electrode body. Next, this coiled electrode body was put into an iron battery can and a pair of insulation plates were disposed on the upper and lower surfaces of the coiled electrode body. Next, a cathode lead was drawn from the cathode current collector and welded to the safety valve mechanism for which electric conduction with the battery lid was secured. Also, an anode lead was drawn from the anode current collector and welded to the bottom of the battery can.

Thereafter, an electrolytic solution was injected into the battery can. As the electrolytic solution, a solution obtained by dissolving 1.0 mol/dm³ of LiPF₆ as an electrolytic salt in a solvent prepared by mixing ethylene carbonate EC and diethyl carbonate DEC in a ratio by volume of 1:1 was used. Next, the battery lid was caulked through a gasket to secure the safety valve mechanism, heat-sensitive resistance element and battery can to obtain a cylinder type secondary battery having an outside diameter of 18 mm and a height of 65 mm.

### Example 2

A cylinder type secondary battery was produced in the same manner as in Example 1 except that the amount of nickel nitrate to be added was altered to 14.87 parts by weight, the amount of manganese nitrate to be added was altered to 14.67 parts by weight, the amount of lanthanum sulfate La₂(SO₄)₃.9H₂O was altered to 0.45 parts by weight and the amount of the aqueous lithium hydroxide solution used to adjust the amount of lithium was altered to 50 parts by weight.

### Example 3

A cylinder type secondary battery was produced in the same manner as in Example 1 except that 1.32 parts by weight of cerium nitrate Ce(NO₃)₃6.H₂O was used in place of 1.33 parts by weight of lanthanum nitrate.

### Example 4

A cylinder type secondary battery was produced in the same manner as in Example 2 except that 0.45 parts by weight of cerium sulfate Ce₂(SO₄)₃.8H₂O was used in place of 0.89 parts by weight of lanthanum nitrate.

### Example 5

A cylinder type secondary battery was produced in the same manner as in Example 1 except that 1.32 parts by weight of praseodymium nitrate Pr(NO₃)₃.6H₂O was used in place of 1.33 parts by weight of lanthanum nitrate.

### Example 6

A cylinder type secondary battery was produced in the same manner as in Example 2 except that 0.53 parts by weight of praseodymium nitrate Pr(NO₃)₃.6H₂O was used in place of 0.89 parts by weight of lanthanum nitrate.

### Example 7

A cylinder type secondary battery was produced in the same manner as in Example 1 except that 1.30 parts by weight of neodymium nitrate Nd(NO₃)₃.6H₂O was used in place of 1.33 parts by weight of lanthanum nitrate.

### Example 8

A cylinder type secondary battery was produced in the same manner as in Example 2 except that 0.43 parts by weight of neodymium sulfate Nd₂(SO₄)₃.8H₂O was used in place of 0.89 parts by weight of lanthanum nitrate.

### Example 9

A cylinder type secondary battery was produced in the same manner as in Example 1 except that 1.28 parts by weight of samarium nitrate Sm(NO₃)₃.6H₂O was used in place of 1.33 parts by weight of lanthanum nitrate.

### Example 10

A cylinder type secondary battery was produced in the same manner as in Example 2 except that 0.42 parts by weight of samarium sulfate Sm₂(SO₄)₃.8H₂O was used in place of 0.89 parts by weight of lanthanum nitrate.

### Example 11

A cylinder type secondary battery was produced in the same manner as in Example 1 except that 1.27 parts by weight of europium nitrate Eu(NO₃)₃.6H₂O was used in place of 1.33 parts by weight of lanthanum nitrate.

### Example 12

A cylinder type secondary battery was produced in the same manner as in Example 2 except that 0.42 parts by weight of europium sulfate Eu₂(SO₄)₃.8H₂O was used in place of 0.89 parts by weight of lanthanum nitrate.

### Example 13

A cylinder type secondary battery was produced in the same manner as in Example 1 except that 1.25 parts by weight of gadolinium nitrate Gd(NO₃)₃.6H₂O was used in place of 1.33 parts by weight of lanthanum nitrate.

### Example 14

A cylinder type secondary battery was produced in the same manner as in Example 2 except that 0.42 parts by weight of gadolinium sulfate Gd(NO₃)₃.8H₂O was used in place of 0.89 parts by weight of lanthanum nitrate.

### Example 15

A cylinder type secondary battery was produced in the same manner as in Example 1 except that 1.24 parts by weight of terbium nitrate Tb(NO₃)₃.6H₂O was used in place of 1.33 parts by weight of lanthanum nitrate.

### Example 16

A cylinder type secondary battery was produced in the same manner as in Example 2 except that 0.41 parts by weight of terbium sulfate Tb₂(SO₄)₃.8H₂O was used in place of 0.89 parts by weight of lanthanum nitrate.

### Example 17

A cylinder type secondary battery was produced in the same manner as in Example 1 except that 1.22 parts by weight of dysprosium nitrate Dy(NO₃)₃.6H₂O was used in place of 1.33 parts by weight of lanthanum nitrate.

### Example 18

A cylinder type secondary battery was produced in the same manner as in Example 2 except that 0.41 parts by weight of dysprosium sulfate Dy₂(SO₄)₃.8H₂O was used in place of 0.89 parts by weight of lanthanum nitrate.

### Example 19

A cylinder type secondary battery was produced in the same manner as in Example 1 except that 1.17 parts by weight of holmium nitrate Ho(NO₃)₃.5H₂O was used in place of 1.33 parts by weight of lanthanum nitrate.

### Example 20

A cylinder type secondary battery was produced in the same manner as in Example 2 except that 0.47 parts by weight of holmium nitrate Ho(NO₃)₃.5H₂O was used in place of 0.89 parts by weight of lanthanum nitrate.

### Example 21

A cylinder type secondary battery was produced in the same manner as in Example 1 except that 1.16 parts by weight of erbium nitrate Er(NO₃)₃.5H₂O was used in place of 1.33 parts by weight of lanthanum nitrate.

### Example 22

A cylinder type secondary battery was produced in the same manner as in Example 2 except that 0.46 parts by weight of erbium nitrate Er(NO₃)₃.5H₂O was used in place of 0.89 parts by weight of lanthanum nitrate.

### Example 23

A cylinder type secondary battery was produced in the same manner as in Example 1 except that 1.39 parts by weight of thulium nitrate Tm(NO₃)₃.6H₂O was used in place of 1.33 parts by weight of lanthanum nitrate.

### Example 24

A cylinder type secondary battery was produced in the same manner as in Example 2 except that 0.55 parts by weight of thulium nitrate Tm(NO₃)₃.6H₂O was used in place of 0.89 parts by weight of lanthanum nitrate.

### Example 25

A cylinder type secondary battery was produced in the same manner as in Example 1 except that 1.14 parts by weight of ytterbium nitrate Yb(NO₃)₃.5H₂O was used in place of 1.33 parts by weight of lanthanum nitrate.

### Example 26

A cylinder type secondary battery was produced in the same manner as in Example 2 except that 0.46 parts by weight of ytterbium nitrate Yb(NO₃)₃.5H₂O was used in place of 0.89 parts by weight of lanthanum nitrate.

### Example 27

A cylinder type secondary battery was produced in the same manner as in Example 1 except that 17.6 parts by weight of lutetium nitrate (a nitric acid solution of Lu(NO₃)₃, ICP standard solution, 25 mg metal Lu/mL, 2 to 5% nitric acid solution) which was a commercially available reagent was used in place of 1.33 parts by weight of lanthanum nitrate.

### Example 28

A cylinder type secondary battery was produced in the same maimer as in Example 2 except that 7.04 parts by weight of lutetium nitrate (a nitric acid solution of Lu(NO₃)₃, ICP standard solution, 25 mg metal Lu/mL, 2 to 5% nitric acid solution) which was a commercially available reagent was used in place of 0.89 parts by weight of lanthanum nitrate.

### Example 29

A cylinder type secondary battery was produced in the same manner as in Example 1 except that 0.03 parts by weight of praseodymium nitrate Pr(NO₃)₃.6H₂O was used in place of 1.33 parts by weight of lanthanum nitrate.

### Example 30

A cylinder type secondary battery was produced in the same manner as in Example 1 except that 7.00 parts by weight of praseodymium nitrate Pr(NO₃)₃.6H₂O was used in place of 1.33 parts by weight of lanthanum nitrate.

### <Comparison 1>

A cylinder type secondary battery was produced in the same manner as in Example 1 except that lithium cobaltate used in Example 1 was used as the cathode active material without disposing the surface layer and coating layer.

### <Comparison 2>

A cylinder type secondary battery was produced in the same manner as in Example 1 except that lanthanum nitrate was not added.

### <Comparison 3>

A cylinder type secondary battery was produced in the same manner as in Example 2 except that lanthanum nitrate was not added.

### (Evaluation of the Cylinder Type Secondary Battery)

### (a) Initial Capacity

The cylinder type secondary battery produced in the above manner was allowed to charge and discharge at an environmental temperature of 45° C. to find the discharge capacity in the first cycle as the initial capacity.

In the charging operation, constant-current charging was conducted under a constant current of 1000 mA until the battery voltage reached 4.40 V and then, constant-voltage charging was conducted at a constant voltage of 4.40 V until the total charging time was 2.5 hours. Also, in the discharging operation, constant-current discharging was conducted under a constant current of 800 mA until the battery voltage reached 2.75 V.

### Retention Rate of Capacity

The cylinder type secondary battery of which the initial capacity was found in the above (a) was allowed to charge and discharge in the same condition until 200 cycles was carried out to measure the discharge capacity in the 200th cycle, thereby finding the retention rate of capacity according to the equation: (Discharge capacity in the 200th cycle/Initial capacity)×100.

The results of the evaluation are shown in Table 1.

TABLE 1

| | | | | | | | AMOUNT | | |
|---|---|---|---|---|---|---|---|---|---|
| | | | | | | | OF | | |
| | | | | COATING LAYER | | | AQUEOUS | | |
| | | SURFACE LAYER | | | | CONTENT | LiOH | | RE- |
| | | NICKEL | MAN- | | MIXING | WITH | SOLUTION | | TENTION |
| | | NITRATE | GANESE | | AMOUNT | RESPECT | TO BE | INITIAL | RATE |
| | COMPOSITE | (PARTS | NITRATE | | (PARTS | TO OXIDE | ADDED | CA- | OF CA- |
| | OXIDE | BY | (PARTS BY | | BY | (PARTS BY | (PARTS BY | PACITY | PACITY |
| | PARTICLES | WEIGHT) | WEIGHT) | MATERIAL | WEIGHT) | WEIGHT) | WEIGHT) | (mAh) | (%) |
| EXAMPLE 1 | LITHIUM | 11.15 | 3.67 | La(NO3)3•6H2O | 1.33 | 0.47(La2O3) | 25 | 2460 | 85 |
| EXAMPLE 2 | COBALTATE | 14.87 | 14.67 | La2(SO4)3•9H2O | 0.45 | 0.18(La2O3) | 50 | 2460 | 83 |
| EXAMPLE 3 | | 11.15 | 3.67 | Ce(NO3)3•6H2O | 1.32 | 0.47(Ce2O3) | 25 | 2450 | 84 |
| EXAMPLE 4 | | 14.87 | 14.67 | Ce2(SO4)3•8H2O | 0.45 | 0.18(Ce2O3) | 50 | 2450 | 83 |
| EXAMPLE 5 | | 11.15 | 3.67 | Pr(NO3)3•6H2O | 1.32 | 0.47(Pr2O3) | 25 | 2430 | 87 |
| EXAMPLE 6 | | 14.87 | 14.67 | Pr(NO3)3•6H2O | 0.53 | 0.18(Pr2O3) | 50 | 2460 | 87 |
| EXAMPLE 7 | | 11.15 | 3.67 | Nd(NO3)3•6H2O | 1.30 | 0.47(Nd2O3) | 25 | 2440 | 87 |
| EXAMPLE 8 | | 14.87 | 14.67 | Nd2(SO4)3•8H2O | 0.43 | 0.18(Nd2O3) | 50 | 2450 | 86 |
| EXAMPLE 9 | | 11.15 | 3.67 | Sm(NO3)3•6H2O | 1.28 | 0.47(Sm2O3) | 25 | 2440 | 86 |
| EXAMPLE 10 | | 14.87 | 14.67 | Sm2(SO4)3•8H2O | 0.42 | 0.18(Sm2O3) | 50 | 2450 | 85 |
| EXAMPLE 11 | | 11.15 | 3.67 | Eu(NO3)3•6H2O | 1.27 | 0.47(Eu2O3) | 25 | 2450 | 84 |
| EXAMPLE 12 | | 14.87 | 14.67 | Eu2(SO4)3•8H2O | 0.42 | 0.18(Eu2O3) | 50 | 2460 | 83 |
| EXAMPLE 13 | | 11.15 | 3.67 | Gd(NO3)3•6H2O | 1.25 | 0.47(Gd2O3) | 25 | 2440 | 86 |
| EXAMPLE 14 | | 14.87 | 14.67 | Gd2(SO4)3•8H2O | 0.42 | 0.18(Gd2O3) | 50 | 2450 | 85 |
| EXAMPLE 15 | | 11.15 | 3.67 | Tb(NO3)3•6H2O | 1.24 | 0.47(Tb2O3) | 25 | 2430 | 87 |
| EXAMPLE 16 | | 14.87 | 14.67 | Tb2(SO4)3•8H2O | 0.41 | 0.18(Tb2O3) | 50 | 2440 | 85 |
| EXAMPLE 17 | | 11.15 | 3.67 | Dy(NO3)3•6H2O | 1.22 | 0.47(Dy2O3) | 25 | 2430 | 82 |
| EXAMPLE 18 | | 14.87 | 14.67 | Dy2(SO4)3•8H2O | 0.41 | 0.18(Dy2O3) | 50 | 2440 | 82 |
| EXAMPLE 19 | | 11.15 | 3.67 | Ho(NO3)3•5H2O | 1.17 | 0.47(Ho2O3) | 25 | 2410 | 83 |
| EXAMPLE 20 | | 14.87 | 14.67 | Ho(NO3)3•5H2O | 0.47 | 0.18(Ho2O3) | 50 | 2430 | 82 |
| EXAMPLE 21 | | 11.15 | 3.67 | Er(NO3)3•5H2O | 1.16 | 0.47(Er2O3) | 25 | 2450 | 86 |
| EXAMPLE 22 | | 14.87 | 14.67 | Er(NO3)3•5H2O | 0.46 | 0.18(Er2O3) | 50 | 2450 | 84 |
| EXAMPLE 23 | | 11.15 | 3.67 | Tm(NO3)3•6H2O | 1.39 | 0.47(Tm2O3) | 25 | 2460 | 86 |
| EXAMPLE 24 | | 14.87 | 14.67 | Tm(NO3)3•6H2O | 0.55 | 0.18(Tm2O3) | 50 | 2470 | 85 |
| EXAMPLE 25 | | 11.15 | 3.67 | Yb(NO3)3•5H2O | 1.14 | 0.47(Yb2) | 25 | 2450 | 86 |
| EXAMPLE 26 | | 14.87 | 14.67 | Yb(NO3)3•5H2O | 0.46 | 0.18(Yb2O3) | 50 | 2460 | 85 |
| EXAMPLE 27 | | 11.15 | 3.67 | Lu(NO3)3 aq.Soln. | 17.6 | 0.47(Lu2O3) | 25 | 2450 | 85 |
| EXAMPLE 28 | | 14.87 | 14.67 | Lu(NO3)3 aq.Soln. | 7.04 | 0.18(Lu2O3) | 50 | 2450 | 84 |
| EXAMPLE 29 | | 11.15 | 3.67 | Pr(NO3)3•6H2O | 0.03 | 0.01(Pr2O3) | 25 | 2470 | 81 |
| EXAMPLE 30 | | 11.15 | 3.67 | Pr(NO3)3•6H2O | 7.00 | 2.5(Pr2O3) | 25 | 2380 | 83 |
| COMPARISON 1 | LITHIUM | — | — | — | — | — | 25 | 2510 | 30 |
| COMPARISON 2 | COBALTATE | 11.15 | 3.67 | — | — | — | 25 | 2470 | 79 |
| COMPARISON 3 | | 14.87 | 14.67 | — | — | — | 50 | 2460 | 80 |

As is understood from Table 1, Examples 1 to 30 using the structure of the present application of this case were further improved in the retention rate of capacity than Comparisons 1 to 3, while keeping the same initial capacity. Specifically, a nonaqueous electrolyte secondary battery having a high initial capacity and high retention rate of capacity can be obtained by using the cathode active material according to the embodiment of this case, the cathode active material being provided with a coating layer including an oxide containing lithium Li and at least one coating element selected from nickel Ni and manganese Mn on at least a part of the composite oxide particles and a surface layer including an oxide containing lanthanoid on at least a part of the coating layer.

Also, when, like Example 29, the amount of lanthanoid in the coating layer is too small, the effect of improving the retention rate of capacity is scarcely produced. Also, when the amount of lanthanoid in the coating layer is too large, lanthanoid does not contribute to the battery reaction and therefore, the initial capacity decreases. It is therefore preferable to prepare the coating layer such that the amount of lanthanoid is 0.02 parts by weight or more and 2.0 parts by weight or less with respect to 100 parts by weight of the baked cathode active material.

The present embodiment is not limited to the aforementioned embodiments. It should be understood by those skilled in the art that various modifications, combinations, sub-combinations and alterations may occur depending on design requirements and other factors insofar as they are within the scope of the appended claims or the equivalents thereof. For example, the battery is not limited in its form but may be have any form including an angular type, coin type or button type.

Also, though the explanations are furnished as to the nonaqueous electrolyte secondary battery having an electrolytic solution in the first example and as to the nonaqueous electrolyte secondary battery having a gel electrolyte in the second example, the embodiments are not limited to these examples.

For example, besides the above electrolytes, a polymer solid electrolyte utilizing an ion conductive macromolecule or an inorganic solid electrolyte utilizing an ion conductive inorganic material may be used as the electrolyte. Also, these electrolytes may be used alone or in combination with other electrolytes. Examples of the polymer compound to be used as the polymer solid electrolyte may include a polyether, polyester, polyphosphazene and polysiloxane. Examples of the inorganic solid electrolyte may include ion conductive ceramics, ion conductive crystal and ion conductive glass.

Moreover, for example, current nonaqueous solvent type electrolytic solutions may be used without any particular limitation as the electrolytic solution used in the nonaqueous electrolyte secondary battery. As the electrolytic solution made of a nonaqueous electrolytic solution containing an alkali metal salt and used in the secondary battery among these current nonaqueous solvent type electrolytic solutions, propylene carbonate, ethylene carbonate, γ-butyrolactone, n-methylpyrrolidone, acetonitrile, N,N-dimethylformamide, dimethylsulfoxide, tetrahydrofuran, 1,3-dioxolan, methyl formate, sulfolane, oxazolidone, thionyl chloride, 1,2-dimethoxyethane, diethylene carbonate and derivatives and mixtures of these compounds are preferably used. As the electrolyte contained in the electrolytic solution, for example, halogenated materials of an alkali metal such as calcium, perchlorates, thiocyanate, boron fluoride, phosphorous fluoride, arsenic fluoride, aluminum fluoride and trifluoromethyl sulfate are preferably used.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A cathode active material for nonaqueous electrolyte secondary battery, the cathode active material comprising:
composite oxide particles including at least lithium and cobalt;
a coating layer disposed on at least a part of the surface of said composite oxide particles and including an oxide including lithium and at least one coating element selected from nickel and manganese; and
a surface layer disposed on at least a part of said coating layer and including an oxide including at least one element selected from among lanthanoids.

2. The cathode active material for nonaqueous electrolyte secondary battery according to claim 1, wherein the amount of the lanthanoid on said surface layer as converted into the weight of lanthanoid oxide is preferably 0.02 parts by weight or more and 2.0 parts by weight or less with respect to 100 parts by weight of said cathode active material for nonaqueous electrolyte secondary battery.

3. The cathode active material for nonaqueous electrolyte secondary battery according to claim 2, wherein said lanthanoid includes lanthanum, cerium, praseodymium, neodymium, samarium, europium, gadolinium, terbium, dysprosium, holmium, erbium, thulium, ytterbium and lutetium.

4. The cathode active material for nonaqueous electrolyte secondary battery according to claim 1, wherein said composite oxide particles have an average composition represented by the following formula:
Li₍₁₊ₓ₎Co_{(1-y)}MyO_{(2-z)} (Chemical formula 1)
wherein M represents at least one element selected from the group consisting of magnesium, aluminum, boron, titanium, vanadium, chromium, manganese, iron, nickel, copper, zinc, molybdenum, tin, calcium, strontium, tungsten, yttrium and zirconium, and x, y and z satisfy the following relations: −0.10≦x≦0.10, 0≦y<0.50 and −0.10≦z≦0.20.

5. The cathode active material for nonaqueous electrolyte secondary battery according to claim 1, wherein the structural ratio of nickel to manganese in said coating layer has a molar ratio of 100:0 to 30:70.

6. The cathode active material for nonaqueous electrolyte secondary battery according to claim 1, wherein said nickel and manganese in said coating layer is replaced with at least one metal element selected from magnesium, aluminum, boron, titanium, vanadium, chromium, iron, cobalt, copper, zinc, molybdenum, tin, calcium, strontium, tungsten, yttrium and zirconium in an amount of 40 mol % or less of the total amount of nickel Ni and manganese.

7. The cathode active material for nonaqueous electrolyte secondary battery according to claim 1, wherein said coating layer is in an amount ranging from 0.5 parts by weight to 50 parts by weight with respect to 100 parts by weight of the above composite oxide particles.

8. The cathode active material for nonaqueous electrolyte secondary battery according to claim 1, the cathode active material having an average particle diameter in a range of 2.0 μm or more to 50 μm or less.

9. A method of producing a cathode active material for nonaqueous electrolyte secondary battery, the method comprising:
forming a layer including a hydroxide including nickel and/or manganese on at least a part of composite oxide particles containing at least lithium and cobalt and then, forming a layer including a hydroxide of at least one element selected from among lantanoids on at least a part of said composite oxide particles; and
forming a coating layer including an oxide containing lithium and at least one coating element selected from nickel and manganese and a surface layer including an oxide of at least one element selected among lanthanoids on at least a part of the composite oxide particles by heat treatment.

10. The method of producing a cathode active material for nonaqueous electrolyte secondary battery according to claim 9, wherein the amount of the lanthanoid on said surface layer as converted into the weight of lanthanoid oxide is preferably 0.02 parts by weight or more and 2.0 parts by weight or less with respect to 100 parts by weight of said cathode active material for nonaqueous electrolyte secondary battery.

11. The method of producing a cathode active material for nonaqueous electrolyte secondary battery according to claim 9, wherein said composite oxide particles have an average composition represented by the following formula:
Li₍₁₊ₓ₎CO_{(1-y)}MyO_{(2-z)} (Chemical formula 1)
wherein M represents at least one element selected from the group consisting of magnesium, aluminum, boron, titanium, vanadium, chromium, manganese, iron, nickel, copper, zinc, molybdenum, tin, calcium, strontium, tungsten, yttrium and zirconium,and x, y and z satisfy the following relations: −0.10≦x≦0.10, 0≦y<0.50 and −0.10≦z≦0.20.

12. The method of producing a cathode active material for nonaqueous electrolyte secondary battery according to claim 9, wherein said hydroxide containing nickel and/or manganese is adhered by dispersing said composite oxide particles in a solvent primarily containing water at a pH 12 or more and then by adding said compound of nickel and/or said component of manganese.

13. The method of producing a cathode active material for nonaqueous electrolyte secondary-battery according to claim 12, wherein said solvent primarily containing water contains lithium hydroxide.

14. The method of producing a cathode active material for nonaqueous electrolyte secondary battery according to claim 9, wherein the structural ratio of nickel to manganese in said coating layer has a molar ratio of 100:0 to 30:70.

15. The method of producing a cathode active material for nonaqueous electrolyte secondary battery according to claim 9, wherein said nickel and manganese in said coating layer is replaced with at least one metal element selected from magnesium, aluminum, boron, titanium, vanadium, chromium, iron, cobalt, copper, zinc, molybdenum, tin, calcium, strontium, tungsten, yttrium and zirconium in an amount of 40 mol % or less of the total amount of nickel and manganese.

16. The method of producing a cathode active material for nonaqueous electrolyte secondary battery according to claim 9, wherein said coating layer is in an amount ranging from 0.5 parts by weight to 50 parts by weight with respect to 100 parts by weight of the above composite oxide particles.

17. The method of producing a cathode active material for nonaqueous electrolyte secondary battery according to claim 9, wherein the cathode active material having an average particle diameter in a range of 2.0 μm or more to 50 μm or less.

18. A method of producing a cathode active material for nonaqueous electrolyte secondary battery, the method comprising:
forming a layer including a hydroxide containing nickel and/or manganese on at least a part of composite oxide particles containing at least lithium and cobalt; and
coating the surface of said composite oxide particles with an oxide of at least one element selected from among lanthanoids and then, forming a coating layer including an oxide containing lithium and at least one coating element selected from nickel and manganese and a surface layer including an oxide of at least one element selected among lanthanoids on at least a part of said composite oxide particles by heat treatment.

19. A nonaqueous electrolyte secondary battery including a cathode having a cathode active material for aqueous electrolyte secondary battery, an anode and an electrolyte, wherein said cathode active material comprises:
composite oxide particles containing at least lithium and cobalt;
a coating layer disposed on at least a part of the surface of said composite oxide particles and including an oxide containing lithium and at least one coating element selected from nickel and manganese; and
a surface layer disposed on at least a part of said coating layer and including an oxide containing at least one element selected from among lanthanoids.
